(19) United States
(12) Patent Application Publication
(10) Pub. No.: US 2022/0134863 A1
(43) Pub. Date: May 5, 2022

(54) Hybrid Transmission Assembly for a Motor Vehicle Powertrain, and Method for Operating a Hybrid Powertrain

(71) Applicant: ZF Friedrichshafen AG, Friedrichshafen (DE)

(72) Inventors: Stefan Beck, Eriskirch (DE); Johannes Kaltenbach, Friedrichshafen (DE); Fabian Kutter, Kressbronn (DE); Matthias Horn, Tettnang (DE); Michael Wechs, Weißensberg (DE); Thomas Martin, Weissensberg (DE); Martin Brehmer, Tettnang (DE); Peter Ziemer, Tettnang (DE); Thomas Kroh, Lindau (DE); Oliver Bayer, Hörbranz (AT); Max Bachmann, Friedrichshafen (DE)

(21) Appl. No.: 17/432,273

(22) PCT Filed: Oct. 15, 2019
(86) PCT No.: PCT/EP2019/077938

§ 371 Date: Aug. 19, 2021

(30) Foreign Application Priority Data
Mar. 5, 2019 (DE) 10 2019 202 969.8

(51) Int. Cl. B60K 6/547; B60K 6/40; B60K 6/36; B60K 6/387; F16H 3/091; B60K 6/44

(52) U.S. Cl. CPC B60K 6/547; B60K 6/40; B60K 6/36; B60Y 2200/92; F16H 3/091; B60K 6/44; B60K 6/387

(57) ABSTRACT

A hybrid transmission arrangement (16) for a motor vehicle drive train (10) includes a first sub-transmission (32) with a first input shaft (24), a second sub-transmission (34) with a second input shaft (26), a first electric machine (56) connectable to the first input shaft (24) via a second clutch (K2), and a second electric machine (60) connected to the second input shaft (26). The first electric machine (56) is connected via a first gearwheel (70) to an intermediate element (74), which forms an input element of the second clutch (K2). The second electric machine (60) is connected to the second input shaft (26) via a second gearwheel (72). The first gearwheel (70) and the second gearwheel (72) are arranged coaxially and adjacent to each other.

### CROSS-REFERENCE TO RELATED APPLICATIONS

The present application is related and has right of priority to German Patent Application No. 102019202969.8 filed in the German Patent Office on Mar. 5, 2019 and is a nationalization of PCT/EP2019/077938 filed in the European Patent Office on Oct. 15, 2019, both of which are incorporated by reference in their entirety for all purposes.

### FIELD OF THE INVENTION

The present invention relates generally to a hybrid transmission arrangement for a motor vehicle drive train, with a first sub-transmission, which includes a first input shaft, with a second sub-transmission, which includes a second input shaft, with a first electric machine, which is connectable to the first input shaft via a second clutch, and with a second electric machine, which is connected to the second input shaft.

The present invention further relates generally to a method for operating a hybrid drive train.

### BACKGROUND

A hybrid transmission arrangement of the above-described type is known from document DE 10 2006 036 758 A1. The automated dual-clutch transmission disclosed therein includes two input shafts and at least one output shaft and an unsynchronized gear clutch, wherein associated with each of the input shafts is a separate clutch for connection to the drive shaft of a prime mover and, for connection to the output shaft, a group of gear-step gearwheels, in each case, having different ratios and each including one fixed gear and one idler gear, which is engageable by an associated gear clutch. In order to simplify the configuration and the controllability, the two clutches are designed as unsynchronized dog clutches. Two electric machines, which are alternately drivingly connected to one of the input shafts, are provided as starting and synchronizing means.

Dual-clutch transmissions have represented an alternative to torque converter automatic transmissions for several years. Dual-clutch transmissions have a dual-clutch assembly, which is connectable on the input side to a prime mover such as an internal combustion engine. An output element of a first friction clutch of the clutch assembly is connected to a first input shaft of a first sub-transmission, which is typically associated with the even forward gear steps or with the odd forward gear steps. An output element of a second friction clutch of the dual-clutch assembly is connected to a second input shaft of a second sub-transmission, which is typically associated with the other forward gear steps.

The gear steps associated with the sub-transmissions can generally be engaged and disengaged in an automated manner. During normal operation, one of the clutches of the dual-clutch assembly is engaged. In the other, inactive, sub-transmission, a connecting gear step can then be engaged in advance. A gear change can then be carried out essentially without interruption of tractive force by an overlapping actuation of the two friction clutches.

Motor vehicle transmissions are generally designed either for the front or the rear transverse installation in a motor vehicle, wherein attention is paid, in particular, to a short axial installation length. Alternatively, transmissions are designed for a longitudinal installation in a motor vehicle, wherein attention is paid, in particular, to a radially compact design.

In the front-mounted and rear-mounted transverse transmissions, two countershafts arranged axially parallel are frequently associated with an input shaft arrangement, and so the power flow can take place from the input shaft arrangement either via the one countershaft or via the other countershaft. The countershafts are also designed as output shafts and, in general, are both in engagement with a differential for distributing input power to driven wheels.

A further trend in the field of motor vehicle drive trains is hybridization. In general, this means a prime mover in the form of an internal combustion engine has associated therewith an electric machine, as a further prime mover. Here, a distinction is made between a plurality of different concepts, which each provide a different connection of the electric machine to the transmission. In a typical variant of dual-clutch transmissions, an electric machine is arranged concentrically to an input element of the dual-clutch assembly. In order to be able to utilize the electric machine, in this case, not only for assisting the internal combustion engine, but rather also to be able to set up a purely electric motor-driven operation, the input element of the dual-clutch assembly is generally connected to the internal combustion engine by a separating clutch or an internal combustion engine-decoupling device.

The hybridization of transmissions, with respect to the requirements mentioned at the outset, places high requirements on radial and/or axial installation space.

In the dual-clutch transmission described in DE 10 2006 036 758 A1 mentioned at the outset, an electric machine is associated with each sub-transmission. Moreover, the dual-clutch assembly is formed by two unsynchronized dog clutches. The rotational-speed adaptations necessary for pulling away from rest and for the synchronization during gear changes are implemented by the electric machines. The unsynchronized dog clutches are combined in a shared clutch block, which has two engagement positions, in which one of the two clutches is engaged in each case, and a neutral position with a completely interrupted power flow. During gear changes in an internal combustion engine-driven operation, a changeover of the clutches of the dual-clutch assembly is always necessary. Moreover, depending on the type of the gear change, one or both electric machine(s) must be actuated for the synchronization and/or for the load transfer. Moreover, the internal combustion engine must always self-synchronize during these types of gear changes.

### SUMMARY OF THE INVENTION

Example aspects of the present invention provide an improved hybrid transmission arrangement for a motor vehicle drive train and improved methods for operating a hybrid transmission arrangement of this type.

Example aspects of the present invention provide, on the one hand, a hybrid transmission arrangement for a motor vehicle drive train, with a first sub-transmission, which includes a first input shaft, with a second sub-transmission, which includes a second input shaft, with a first electric machine, which is connectable to the first input shaft via a second clutch, and with a second electric machine, which is connected to the second input shaft. The first electric machine is connected via a first gearwheel to an intermediate element, which forms an input element of the second clutch. The second electric machine is connected to the second input shaft via a second gearwheel. The first gearwheel and the second gearwheel are arranged coaxially and adjacent to each other.

Moreover, example aspects of the present invention provide a method for operating a hybrid transmission arrangement of the type according to example aspects of the invention, including, during an internal combustion engine-driven operation or a hybrid operation, utilizing the gear steps of the one sub-transmission by engaging the first clutch and the second clutch, and utilizing the gear steps of the other sub-transmission by engaging the first clutch and the second clutch and the third clutch.

Moreover, example aspects of the present invention provide a method for operating a hybrid transmission arrangement of the type according to example aspects of the invention, including, in an internal combustion engine-driven operation, disengaging the third clutch in a gear step of the one sub-transmission, in order to decouple the other sub-transmission and the electric machine associated with the other sub-transmission.

Moreover, example aspects of the present invention provide a method for operating a hybrid drive train of the type according to example aspects of the invention, including, in a purely electric motor-driven operation, providing input power of the first electric machine via the first sub-transmission and/or providing input power of the second electric machine via the second sub-transmission, and/or implementing a powershift, in that one of the electric machines maintains the tractive force via the associated sub-transmission, while a gear change is carried out in the other sub-transmission.

In addition, both electric machines can be utilized as a generator or as a motor in a serial operation. In the present case, a serial operation is understood to mean that, in a purely electric motor-driven operation by one of the two electric machines, the other electric machine is simultaneously driven by the internal combustion engine and operated as a generator, in order to charge a vehicle battery. The vehicle battery is preferably the same battery from which the electric machine operating as a motor draws power.

The second clutch, which is preferably always engaged in the normal internal combustion engine-driven operation and in the normal hybrid operation, is preferably disengaged during the serial operation. In the serial operation, the first clutch is engaged. In the serial operation, the second electric machine operates as a motor via the second sub-transmission and provides electric motor-generated power for a purely electric motor-driven operation, for example, for an operation in a low gear step (for example, second gear), in order to drive a vehicle in a “crawler gear”. In a crawler gear of this type, the ground speed of the vehicle is generally below a speed, at which the internal combustion engine can be utilized as a prime mover (due to the ratio of the lowest gear step or starting gear step). In order to also be able to permanently establish a low ground speed of this type beyond the maximum capacity of the vehicle battery, the above-described serial operation can be implemented. In the serial operation, it is preferred when the internal combustion engine provides input power via the engaged first clutch, in order to operate the first electric machine as a generator.

In addition, with the hybrid transmission arrangement according to example aspects of the invention, it is possible to utilize an electric machine for synchronization during gear changes in an internal combustion engine-driven operation or a hybrid operation, i.e., to assist the internal combustion engine during synchronization with an electric machine. In other words, in the internal combustion engine-driven operation or in the hybrid operation, one of the electric machines is always connected to the internal combustion engine. As a result, a load-point displacement at the internal combustion engine is possible and this electric machine can assist during the closed-loop control of the rotational speed when a shift element, such as a gearshift clutch, must be synchronized. Consequently, the internal combustion engine does not need to synchronize “on its own”, but rather is always “picked up” at the current rotational speed of the internal combustion engine by one of the two electric machines.

In the transmission arrangement, the first input shaft and the second input shaft are preferably arranged coaxially to each other. The first input shaft is preferably designed as an inner shaft. The second input shaft is preferably designed as a hollow shaft. The transmission arrangement preferably includes precisely one countershaft. Preferably, the one countershaft is simultaneously an output shaft of the transmission arrangement. For this purpose, the countershaft is preferably connected to an output gear, which is designed for driving a power distribution arrangement, such as a differential.

Engageable gear sets are understood to be, in the present case, gear sets that include an idler gear and a fixed gear, which are in engagement with each other in an intermeshed manner, and which are engageable by an associated gearshift clutch. In an engaged gear set, the idler gear of this gear set is rotationally fixed to the associated shaft. The gear sets are preferably spur gear trains, which preferably connect one of the two input shafts and the countershaft to each other, in each case.

Associated with each gear set, preferably, is a regular forward gear step, i.e., a fixed ratio. The transmission arrangement preferably does not include a gear set, with which a reverse gear step is associated. Travel in reverse is preferably implemented exclusively via one of the electric machines.

In one preferred example embodiment, the first sub-transmission is associated with the odd gear steps. In a corresponding way, the second sub-transmission in one preferred example embodiment is associated with the even forward gear steps.

In the present case, a connection is understood to mean, in particular, that the two elements to be connected to each other are permanently connected to each other in a rotationally fixed manner. Alternatively, however, the two elements can be connected to each other in a rotationally fixed manner as necessary. In the present case, a rotationally fixed connection is understood to mean that the elements connected with the rotationally fixed connection rotate at a rotational speed proportional to each other.

The electric machines are preferably arranged axially parallel to the transmission arrangement. Consequently, the longitudinal axes of the electric machines are preferably arranged in parallel, although offset with respect to the input shafts as well as to the countershaft.

In one preferred example variant, the order of the elements starting from an input of the transmission arrangement is as follows: gear set for the fourth forward gear step 4, gearshift clutch assembly for the fourth and second forward gear steps 4 and 2, gear set for the second forward gear step 2, gearshift clutch assembly with a gearshift clutch for the third forward gear step 3 (or the fifth forward gear step 5) and, optionally, with a third clutch, gear set for the third forward gear step 3 (or the fifth forward gear step 5), gear set for the first forward gear step 1, gearshift clutch assembly for the first and third forward gear steps 1 and 3 (or the first and fifth forward gear steps 1 and 5), and gear set for the third forward gear step 3 (or the fifth forward gear step 5).

The gearshift clutch assemblies for the second and fourth forward gear steps 2 and 4 as well as the first and third forward gear steps 1 and 3 (or the first and fifth forward gear steps 1 and 5) are preferably arranged at a countershaft. A gearshift clutch assembly, which includes the third optional clutch and a gearshift clutch for the fifth forward gear step 5 or the third forward gear step 3, is preferably arranged coaxially to the input shafts.

Preferably, the hybrid transmission arrangement is accommodated in a hybrid drive train, in which an internal combustion engine can provide input power, which, in the simplest case, can be transmitted to the input shafts of the sub-transmissions directly, preferably, however, via the second clutch and/or a first clutch.

According to one preferred example embodiment, the control device is configured for establishing at least the following operating modes:
a purely internal combustion engine-driven operation;
a purely electric operation by the first electric machine; and
a purely electric operation by the second electric machine.

Moreover, the control device is configured for establishing a hybrid operation, in which input power is provided by the internal combustion engine and electric motor-generated input power is provided by the first electric machine and/or the second electric machine. The hybrid traveling mode can be a drive mode, although the hybrid traveling mode can also be a mode, in which mechanical input power is at least partially supplied to the electric machines, in order to operate the electric machines as generators for charging a vehicle battery.

Moreover, the hybrid drive train is preferably configured for carrying out a sailing operation, in which, starting from a moderate or high ground speed, the internal combustion engine is decoupled and the ground speed is maintained, for example, by an intermittent operation of one or both electric machine(s). Stationary charging is also possible.

Due to arranging the first gearwheel and the second gearwheel coaxially and adjacent to each other, the first electric machine and the second electric machine can be connected to the sub-transmissions in an axially compact manner. Adjacent gearwheels are understood to mean, in the present case, that no other gear set or no further gear set plane is arranged between the adjacent gearwheels. Adjacent does not mean, in this context, however, that another element of the hybrid transmission arrangement could not be arranged therebetween, such as, for example, a clutch and/or a bearing, by which the first input shaft or the second input shaft is mounted with respect to a housing.

The second input shaft is preferably designed as a hollow shaft around the first input shaft. The first input shaft preferably extends in the axial direction from an area of the first gearwheel through the second input shaft to the first sub-transmission, which is preferably arranged on a side of the second sub-transmission axially opposite the first gearwheel and the second gearwheel.

According to one preferred example embodiment, the intermediate element, to which the first electric machine is connected, is connected to a transmission arrangement input shaft via a first clutch.

The transmission arrangement input shaft is preferably rotationally fixed to an internal combustion engine in a hybrid drive train.

By providing the first clutch, which can also be referred to as a separating clutch, it is possible to operate a hybrid drive train including, in a purely electric motor-driven operation, providing input power of the first electric machine via the first sub-transmission and/or providing input power of the second electric machine via the second sub-transmission, wherein the first clutch is disengaged, and/or wherein a powershift is implemented, in that one of the electric machines maintains the tractive force via the associated sub-transmission, while a gear change is carried out in the other sub-transmission.

It is particularly preferred when the first gearwheel and/or the intermediate element are/is arranged in the axial direction between the second clutch and the first clutch.

As a result, a compact design can be implemented, and it is possible, in an easy way, to arrange the first gearwheel and the second gearwheel adjacent to each other.

According to one further example embodiment preferred overall, the first input shaft and the second input shaft are connectable via a third clutch.

The third clutch preferably connects the first input shaft and the second input shaft. The third clutch is preferably not a clutch of the type that is utilized for establishing a winding-path gear step in the transmission arrangement. This is the case because, during the establishment of a winding-path gear step, two gear sets of each of the two sub-transmissions are generally involved, in order to implement a ratio that is as low as possible or a ratio that is as high as possible, i.e., in order to allow for a high spread of gear ratios of the transmission arrangement. In the present case, however, power is preferably always transmitted only via one gear set either from the first input shaft to the countershaft or from the second input shaft to the countershaft, and so the spread of gear ratios of the transmission arrangement results preferably exclusively due to the ratios of the regular forward gear steps. Consequently, the transmission arrangement can generally operate with a high efficiency.

The hybrid transmission arrangement according to example aspects of the invention makes it possible, due to the preferred provision of the third clutch for connecting the first sub-transmission and the second sub-transmission, for gear changes to be carried out in an internal combustion engine-driven operation or in a hybrid operation without the need to actuate the first clutch or the second clutch. Moreover, since a separate electric machine is associated with each sub-transmission, both electric machines can be provided for making input power available.

In a purely electric motor-driven operation, it is possible with the preferred hybrid transmission arrangement to disengage the first clutch or the second clutch and to engage the third clutch, and so the two electric machines are coupled to each other and, jointly, can provide input power via a single gear step. Alternatively, it is possible, in a purely electric motor-driven operation, to operate the two electric machines in parallel via the respective particular sub-transmissions and leave the third clutch disengaged.

According to one preferred example embodiment, the third clutch and a gearshift clutch for engaging a gear set of a sub-transmission are accommodated in a gearshift clutch assembly or form a gearshift clutch assembly of this type.

In general, a gearshift clutch assembly is understood to be an arrangement formed from two gearshift clutches, which are alternately actuatable by one single actuating unit. Moreover, a gearshift clutch assembly generally has a neutral position, in which neither of the two gearshift clutches of the assembly is engaged. A gearshift clutch assembly of this type can also be referred to as a double shift element.

It is particularly preferred when the gear set that is engageable by the gearshift clutch assembly is associated with the sub-transmission, the associated second clutch of which is preferably always engaged in the internal combustion engine-driven operation and in the hybrid operation. Preferably, the gear set that is engageable by the gearshift clutch assembly is associated with the first sub-transmission, which is associated with the odd forward gear steps. It is particularly preferred when the gear set is associated with the fifth forward gear step 5 or the third forward gear step 3.

It is preferred, furthermore, when the first electric machine is connected to the first gearwheel via at least one first intermediate gearwheel and/or when the second electric machine is connected to the second gearwheel via at least one second intermediate gearwheel.

The first intermediate gearwheel and/or the second intermediate gearwheel can each be mounted, rotatably with respect to the housing, at further shafts. Via an intermediate gearwheel, a high ratio can be established between a rotor of the particular electric machine and the associated particular input shaft/intermediate shaft.

According to one further preferred example embodiment, the first clutch and/or the second clutch and/or the third clutch and/or at least one gearshift clutch of the transmission arrangement are/is designed as a dog clutch, i.e., as a non-synchronized shift element. A dog clutch of this type includes, in particular, no friction elements for synchronizing components to be connected to each other.

Due to the fact that a separate electric machine is associated with each sub-transmission, functions of the synchronization and/or of the load transfer can take place via the electric machines. Accordingly, the above-mentioned clutches can be designed as dog clutches, and so potential for the reduction of the axial and/or radial installation space can result, as well as weight advantages.

The first clutch and the second clutch can preferably be actuated independently of each other by separate actuating units.

The first electric machine is connected to an intermediate element via a first gearwheel in the hybrid transmission arrangement according to example aspects of the invention. The intermediate element is preferably an intermediate shaft, at which the first gearwheel, as a fixed gear, is fixed. The first gearwheel is preferably arranged, in the axial direction, between a transmission arrangement input shaft and the first input shaft. The first gearwheel is preferably not a gear-forming gearwheel.

On the other hand, the second electric machine is connected to the second input shaft via a second gearwheel. The second gearwheel can be a separate gearwheel, which is not associated with a special gear step.

It is particularly preferred, however, when the second electric machine is connected to the second input shaft via a gear-step gear set of the second sub-transmission.

In general, it is conceivable to arrange the electric machines coaxially to, for example, the particular input shafts of the sub-transmissions. It is preferred, however, when the electric machines are arranged axially parallel to the input shaft arrangement. The connection to the particular input shaft can then take place via a flexible traction drive mechanism or a gear set. A separate gear set can be provided for this purpose. This can have the advantage of a connection having an optimized ratio. As mentioned above, it is preferred, however, when the connection of the second electric machine takes place via a gear-step gear set. Weight can be saved as a result. A ratio adaptation can preferably take place, as mentioned, in that a pinion of the particular electric machine is not directly connected to a gearwheel or is in engagement therewith in an intermeshed manner, but rather in that an intermediate gear is connected therebetween. In particular, the electric machines can be implemented as relatively high-speed machines, which, consequently, can be designed to be compact.

It is particularly preferred when the gear-step gear set of the second sub-transmission, via which the second electric machine is connected to the second input shaft, is associated with the highest gear step of the second sub-transmission.

According to one further preferred example embodiment, the gear-step gear set of the second sub-transmission, via which the second electric machine is connected to the second input shaft, is arranged at one axial end of the transmission arrangement and, in fact, preferably adjacent to the first gearwheel.

This allows for a connection of the electric machines, on the one hand, at the points, at which high bearing forces can be absorbed, since housing walls or bearing plates are generally arranged at the axial ends of the transmission arrangement. Moreover, this allows for a connection of the electric machines in such a way that the connection of of the electric machines remains as unaffected as possible from each other. In addition, this type of connection makes it possible for the electric machines to be arranged in axial overlap with each other. It is particularly preferred when the second electric machine extends between a first axial end of the transmission arrangement and the second axial end of the transmission arrangement. As a result, an axially compact design can also be implemented.

The first electric machine is preferably arranged in axial overlap at least with the second sub-transmission.

According to one further example embodiment preferred overall, the first sub-transmission is associated with the odd forward gear steps and includes three gear sets, which are associated with different forward gear steps, and/or the second sub-transmission is preferably associated with the even forward gear steps and includes two or three gear sets, which are associated with different forward gear steps.

Via five or six forward gear steps, an internal combustion engine-driven operation across a large speed range can be implemented. For very low speed ranges, travel can take place exclusively by electric motor, if necessary.

The transmission arrangement therefore preferably has only five or six gear set planes. Moreover, the transmission arrangement preferably has only three gearshift clutch planes, in each of which preferably precisely one gearshift clutch assembly is arranged.

Preferably, the transmission arrangement includes only precisely five actuating units, of which three are associated with the gearshift clutch assemblies of the transmission arrangement and of which one is associated with the first clutch and one is associated with the second clutch.

According to one example embodiment, the first electric machine and the second electric machine are identical.

This yields cost advantages and stock-control advantages. The two electric machines can then operate practically “equally” within the transmission arrangement and can both be operated alternately as a prime mover for driving a motor vehicle and/or as a generator for charging a vehicle battery.

It is particularly preferred, however, when the second electric machine has a higher power than the first electric machine.

In this preferred example embodiment, the second electric machine is preferably utilized as a prime mover for driving a motor vehicle and, accordingly, has a comparatively high power. The first electric machine is used primarily for providing additional electrical power and/or is provided as a generator, in particular in a serial operation.

It is preferred, furthermore, when an input shaft arrangement formed by the first input shaft and the second input shaft is arranged, as viewed axially, in a center of four quadrants, of which a first quadrant is situated above the input shaft arrangement and on a first longitudinal side of the input shaft arrangement, of which a second quadrant is situated underneath the input shaft arrangement and on the first longitudinal side of the input shaft arrangement, of which a third quadrant is situated underneath the input shaft arrangement and on a second longitudinal side of the input shaft arrangement, and of which a fourth quadrant is situated above the input shaft arrangement and on the second longitudinal side of the input shaft arrangement, and wherein
an axis of the first electric machine or of the second electric machine is situated in the first quadrant and an axis of the other electric machine is situated in the fourth quadrant, and/or
an axis of the countershaft is situated in the second quadrant, and/or
an axis of a power distribution unit is situated in the second quadrant, and/or
actuating units for actuating (i) the first clutch and/or (ii) the second clutch and/or (iii) the third clutch and/or (iv) at least one gearshift clutch for engaging a gear-step gear set of the first sub-transmission and/or (v) at least one gearshift clutch for engaging a gear-step gear set of the second sub-transmission is/are situated in the third quadrant.

Due to the above-described arrangement of at least one axis in at least one of the aforementioned quadrants, a radially and vertically compact hybrid transmission arrangement can be made available, which preferably also has a low center of gravity.

The axis of the power distribution unit is preferably coaxial to driven wheels of the motor vehicle.

The power distribution unit is preferably either arranged completely within the second quadrant or extends partially also into the first quadrant.

The countershaft with the gearwheels arranged thereon is preferably predominantly arranged in the second quadrant, although the countershaft can also partially extend, with the gearwheels, into the third quadrant, preferably, however, not into the first quadrant or into the fourth quadrant.

The first electric machine, including an intermediate gear, is preferably located in the first quadrant. The second electric machine is preferably located, entirely, including an intermediate gear, in the fourth quadrant.

Overall, through the hybrid transmission arrangement, depending on the example embodiment, at least one of the following advantages is achieved:
low design complexity, since preferably only five (if necessary, six) gear set pairs and five actuating units are to be provided;
good efficiency and a simple configuration result, since, in particular, no winding-path gear steps are implemented;
low component loads result;
at least three electric gear steps result for the first electric machine and at least two gear steps result for the second electric machine;
the transmission arrangement includes preferably only one countershaft, which is preferably connected to a power distribution unit via only one output gear set;
gear change operations can be carried out quickly and efficiently, since an engagement of the first clutch and the second clutch is preferably not necessary in an internal combustion engine-driven operation and a hybrid operation and since the synchronization of gear steps is always implementable also by utilizing an electric machine;
a serial operation is implementable with the first electric machine as a generator;
this yields a high versatility in combination with compact dimensions. It is particularly preferred when an internal combustion engine-driven operation and a hybrid operation are established in such a way that the first clutch and the second clutch are engaged (depending on the gear step, the third clutch is disengaged or engaged).

In order to also be able to disengage, under load, the first clutch that is always engaged in this case, for example, in the case of an emergency brake application, it can be preferable to implement this first clutch as a normally disengaged friction clutch.

It is understood that the features, which are mentioned above and which will be described in greater detail in the following, are usable not only in the particular combination indicated, but also in other combinations or alone, without departing from the scope of the present invention.

### BRIEF DESCRIPTION OF THE DRAWINGS

Exemplary embodiments of the invention are represented in the drawings and are explained in greater detail in the following description, wherein

FIG. 1 shows a diagrammatic gear set representation of an example embodiment of a hybrid drive train with a hybrid transmission arrangement; and

FIG. 2 shows an axial view of a preferred example embodiment of a hybrid transmission arrangement with four quadrants represented.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

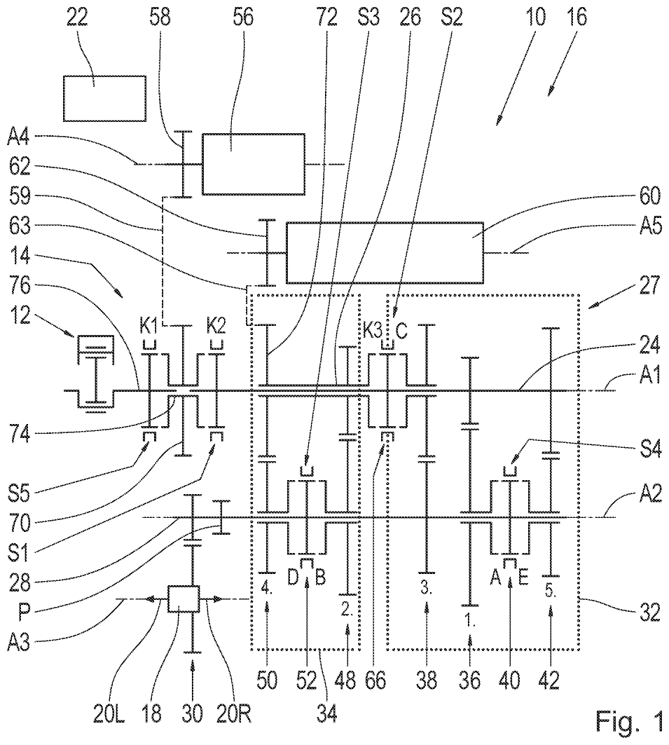

In FIG. 1, a hybrid drive train for a motor vehicle, in particular a passenger car, is represented in diagrammatic form and is labeled, in general, with 10.

The hybrid drive train 10 includes an internal combustion engine 12, which is connected to an input element of a clutch assembly 14. The clutch assembly 14 is connected on the output side to a hybrid transmission arrangement 16. An output of the hybrid transmission arrangement 16 is connected to a power distribution unit 18, which can be designed, for example, as a mechanical differential and can distribute the input power to two driven wheels 20L, 20R of the motor vehicle.

Moreover, the hybrid drive train 10 includes a control device 22 for controlling all components thereof.

The clutch assembly 14 is arranged on an axis A1, which is coaxial to a crankshaft of the internal combustion engine 12. The clutch assembly 14 can include two friction clutches or one friction clutch and a non-synchronized dog clutch. In the present case, the clutch assembly 14 contains two non-synchronized dog clutches K1 and K2. The first clutch K1 has an input element, which is rotationally fixed to the crankshaft of the internal combustion engine 12. The first clutch K1 has a first output element. The second clutch K2 has an input element, which is rotationally fixed to the output element of the first clutch K1, and a second output element. The output elements are arranged coaxially to each other.

The transmission arrangement 16 includes a first input shaft 24 and a second input shaft 26. The input shafts 24, 26 are arranged coaxially to each other and to the axis A1. The first input shaft 24 is designed as an inner shaft. The second input shaft 26 is designed as a hollow shaft.

Moreover, the transmission arrangement 16 includes a countershaft 28, which is designed as an output shaft 28 and is arranged coaxially to a second axis A2. The output shaft 28 is connected via an output gear set 30 to the power distribution unit 18, which is arranged coaxially to an axis A3.

A parking interlock gear P can be rotationally fixed at the output shaft 28 or at an input element of the power distribution unit 18. The hybrid drive train 10 can be immobilized by the parking interlock gear P. The associated parking lock device is not represented, for the sake of clarity.

The transmission arrangement 16 has a first sub-transmission 32 and a second sub-transmission 34. The sub-transmissions 32, 34 are arranged axially offset with respect to each other. The first sub-transmission 32 is arranged adjacent to a first axial end of the transmission arrangement 16. The second sub-transmission 34 is arranged adjacent to a second axial end of the transmission arrangement 16, wherein the second axial end is adjacent to the clutch assembly 14. The sub-transmissions 32, 34 have a plurality of engageable gear sets, which, in the engaged condition, connect an input shaft and the output shaft 28 in each case.

The first sub-transmission 32 has a first gear set 36 for the first forward gear step 1 and a second gear set 38 for the third forward gear step 3. The second gear set 38 is arranged closer to the second axial end of the transmission arrangement 16 than the first gear set 36. Moreover, the first sub-transmission 32 has a third gear set 42 for the fifth forward gear step 5. The third gear set 42 is arranged closer to the first axial end of the transmission arrangement 16 than the first gear set 36. A first gearshift clutch assembly 40 is arranged between the first gear set 36 and the third gear set 42 and, in fact, coaxially to the axis A2. The first gearshift clutch assembly 40 includes a first gearshift clutch A for engaging the first gear set 36 and a second gearshift clutch E for engaging the third gear set 42. The two gearshift clutches A, E are alternately engageable and are designed as non-synchronized dog clutches. The engagement of a gear set includes the rotationally fixed connection of an idler gear of the particular gear set to an associated shaft. In the present case, for example, the first gear set 36 is engaged, in that an idler gear of the first gear set 36, which is rotatably mounted at the output shaft 28, is rotationally fixed to the output shaft 28, in order to bring the first gear set 36 into the power flow in this way.

The second gear set 38 is engageable by a gearshift clutch C and has an idler gear, which is rotatably mounted at the first input shaft 24.

The second sub-transmission 34 has a fourth gear set 48 for the second forward gear step 2 and a fifth gear set 50 for the fourth forward gear step 4. The fifth gear set 50 is arranged closer to the second axial end than the fourth gear set 48. A second gearshift clutch assembly 52 is arranged between the fourth and fifth gear sets 48, 50 and, in fact, coaxially to the axis A2. The second gearshift clutch assembly 52 has a gearshift clutch B for engaging the fourth gear set 48 and a gearshift clutch D for engaging the fifth gear set 50. The gearshift clutches B and D are accommodated in the second gearshift clutch assembly 52 in such a way that the gearshift clutches B, D are alternately actuatable.

Consequently, the transmission arrangement 16 has five gear set planes, namely, starting from the second axial end toward the first axial end, in the following order: gear set 50 for the fourth forward gear step 4; gear set 48 for the second forward gear step 2; gear set 38 for the third forward gear step 3; gear set 36 for the first forward gear step 1; and gear set 42 for the fifth forward gear step 5.

Moreover, the hybrid drive train 10 includes a first electric machine 56, which is arranged coaxially to a fourth axis A4. The first electric machine 56 has a first pinion 58, which is rotationally fixed to a rotor of the first electric machine 56 and is coaxial to the axis A4. The first pinion, which can also be referred to as a first machine pinion, is connected via a first intermediate gear 59 to a first gearwheel 70, which can also be referred to as a machine gearwheel. The first gearwheel 70 is rotationally fixed to an intermediate element in the form of an intermediate shaft 74, which is arranged coaxially to the first axis A1 and forms an output element of the first clutch K1 and an input element of the second clutch K2. The first gearwheel 70 is arranged in the axial direction between the first clutch K1 and the second clutch K2.

Moreover, the hybrid drive train 10 has a second electric machine 60, which is arranged axially parallel to the input shafts 24, 26 and, in fact, coaxially to a fifth axis A5. The second electric machine has a second pinion (second machine pinion) 62, which is arranged coaxially to the axis A5. The second pinion 62 is connected to the second input shaft 26 via a gear-step gear set of the second sub-transmission 34. In the present case, the second pinion 62 is connected to the fifth gear set 50 for the fourth forward gear step 4 via a second intermediate gear 63. More precisely, the second pinion 62 meshes with the second intermediate gear 63, which is rotatably mounted at an axle (not described in greater detail), and the second intermediate gear 63 meshes with a fixed gear of the fifth gear set 50, wherein the fixed gear is rotationally fixed to the second input shaft 26. The fixed gear of the fifth gear set 50 forms a second gearwheel 72.

The five axes A1, A2, A3, A4, A5 are all aligned in parallel with one another.

The clutch assembly 14 is arranged adjacent to the second axial end of the transmission arrangement 16, as mentioned above. An input element of the first clutch K1 is rigidly connected to a transmission arrangement input shaft 76, which, in the drive train 10, is rotationally fixed to a crankshaft of the prime mover 12.

The output gear set 30 is also arranged on the second axial side of the transmission arrangement 16 and is preferably axially aligned with the clutch assembly 14 or is situated approximately in a plane therewith. The parking interlock gear P can be fixed at the output shaft 28 between the output gear set 30 and the fifth gear set 50.

In the hybrid drive train 10, the second electric machine 60 is connected to a gear-step gear set of the associated sub-transmission, which is associated with the highest gear step of that sub-transmission. Moreover, the second electric machine 60 is connected via a gear-step gear set to the associated sub-transmission, which is preferably arranged adjacent to an axial end of the transmission arrangement.

The electric machines 56, 60 are arranged in axial overlap with each other. Due to the connection via intermediate gears 59, 63, high ratios for the particular gearwheels 70, 72 can be established, and so relatively high-speed electric machines can be utilized, which are compact.

The hybrid transmission arrangement in the present example embodiment has precisely five forward gear steps and does not have a reverse gear step. An operation in reverse can be exclusively established by the hybrid drive train 10 when one of the electric machines 56 or 60 is driven in the opposite direction of rotation.

The transmission arrangement 16 has no winding-path gear steps. Each gear set 36 through 50 includes precisely one idler gear and one fixed gear, wherein the idler gears of the gear sets 36, 38, 48, 50 are rotatably mounted at the output shaft 28, and wherein the idler gear of the gear set 42 is rotatably mounted at the first input shaft 24.

Moreover, the hybrid drive train 10 includes a third clutch K3, which can also be referred to as a bridge clutch.

The third clutch K3 is utilized for connecting the first input shaft 24 and the second input shaft 26. The third clutch K3 is arranged adjacent to the fourth gear set 48 for the second forward gear step 2 and is accommodated, with the gearshift clutch C for the second gear set 38 for engaging the third forward gear step 3, in a third gearshift clutch assembly 66. The third clutch K3, just like the gearshift clutches A, B, C, D, E, is implemented as a non-synchronized dog clutch.

The third gearshift clutch assembly 66 is arranged coaxially to the first axis A1 and, in fact, axially between the gear sets 38, 48.

The clutch assembly 14 with the first clutch K1 and the second clutch K2, and the three gearshift clutch assemblies 40, 52, 66 are actuatable by five actuating units S1 through S5.

One actuating unit S1 is utilized for actuating the second clutch K2, and can either engage or disengage the clutch K2. One actuating unit S5 is utilized independently thereof for actuating the first clutch K1 and can either engage or disengage the first clutch K1.

Moreover, the first gearshift clutch assembly 40 can be actuated by a fourth actuating unit S4. By the fourth actuating unit S4, either the gearshift clutch A can be engaged, or the gearshift clutch C can be engaged, or a neutral position can be established.

In a corresponding way, the second gearshift clutch assembly 52 can be actuated by a third actuating unit S3, in order to either engage the clutch D, or engage the clutch B, or establish a neutral position.

Finally, the third gearshift clutch assembly 66 can be engaged by a second actuating unit S2, in order to either engage the clutch K3, or engage the clutch C, or establish a neutral position.

With the transmission arrangement 16 from FIG. 1, it is possible to interchange the gear sets for the third and fifth forward gear steps 3 and 5 in the first sub-transmission 32.

Moreover, the second electric machine 60 does not necessarily need to be connected via a gear-step gear set to the associated input shaft 24, 26. Rather, it is also possible to fix a second gearwheel at the second output shaft 26, which is not associated with any gear step and is in engagement with the second pinion 62 directly or via a second intermediate gear.

In the following, different operations are explained, which are establishable with the hybrid drive train 10 from FIG. 1.

In all forward gear steps V1 through V5 establishable in a purely internal combustion engine-driven operation or in a hybrid operation, the first clutch K1 is continuously engaged and the second clutch K2 is also engaged. In the forward gear step V1, the gearshift clutch A is engaged and all other gearshift clutches B through E are disengaged. The third clutch K3 is also disengaged. Consequently, power flows from the internal combustion engine via the first clutch K1 and the second clutch K2 and the first input shaft 24 to the first gear set 36 and, from there, via the gearshift clutch A to the output shaft 28.

It is understood that pulling away from rest generally takes place purely via electric motors 56, 60 until a speed is reached, at which the internal combustion engine can be connected, i.e., at a speed that corresponds to a rotational speed above the idling speed of the internal combustion engine 12. Consequently, pulling away from rest takes place, for example, via the first electric machine 56 and with the first clutch K1 disengaged and the second clutch K2 engaged, and via the first gear set 36 for the forward gear step V1. As soon as a speed has been reached that corresponds to the speed of the internal combustion engine 12, the clutch K1 can be engaged. The clutch K1 remains engaged during the entire internal combustion engine-driven operation. Alternatively, it is possible to keep the clutch K1 engaged and to disengage the clutch K2. In this case, pulling away from rest can take place via the second electric machine 60, for example, with the gearshift clutch B for the forward gear step 2 engaged. The internal combustion engine 12 can then be started by the first electric machine 56.

During the changeover from the forward gear step V1 into the forward gear step V2, initially the gearshift clutch B for the forward gear step 2 is preliminarily engaged. This can take place, if necessary, with the aid of a synchronization by the second electric machine 60.

Thereafter, the gearshift clutch A for the forward gear step V1 is disengaged, wherein the tractive force is supported by the second electric machine 60 and the already engaged gear set 48 for the forward gear step V2. Thereafter, the third clutch K3 can be engaged, wherein the synchronization necessary therefor takes place, on the one hand, by a rotational-speed adaptation of the internal combustion engine 12, but also by appropriate synchronization measures of the first electric machine and/or the second electric machine 60. In the second forward gear step, power flows, consequently, from the internal combustion engine 12 via the first clutch K1, the second clutch K2, the first input shaft 24, the engaged third clutch K3, the second input shaft 26, and the gear set 48 for the second forward gear step, which is engaged by the gearshift clutch B, to the output shaft 28.

During the changeover into the forward gear step V3, the third clutch K3 is disengaged, the tractive force is supported via the second electric machine 60 and, thereafter, the connecting gear step 3 can be engaged in the first sub-transmission 32 by engaging the gearshift clutch C. The necessary synchronization can take place via the first electric machine 56.

Thereafter, the load can be supported by the first electric machine 56 and the gearshift clutch B of the forward gear step 2 can be disengaged.

The further gear changes from the gear steps V3 and V4 and from V4 and V5 result in a corresponding way. In both of the even forward gear steps V2 and V4, the third gearshift clutch K3 is engaged. The first clutch K1 and the second clutch K2 are always engaged.

Moreover, a purely electric motor-driven operation is possible with the first electric machine 56. In a first electric gear step E1.1, the gearshift clutch A for the forward gear step 1 is engaged. The first clutch K1 is disengaged. The second clutch K2 is engaged. In a second electric forward gear step E1.2, the gearshift clutch C, rather than the gearshift clutch A, is engaged. In a third electric-motor gear step E1.3, the gearshift clutch E is engaged.

Moreover, a purely electric motor-driven operation is possible with the second electric machine 60. In a first gear step E2.1, only the gearshift clutch B is engaged, and the third clutch K3 is disengaged. The second clutch K2 and/or the first clutch K1 are/is disengaged. In a second electric gear step E2.2, the gearshift clutch D, rather than the gearshift clutch B, is engaged.

In the purely electric operation, purely electric powershifts (i.e., gear changes between forward gear steps without or with reduced interruption of tractive force) are possible. Here, an electric motor-driven operation is established exclusively, for example, between the gear steps E1.1, E1.2, E1.3 or exclusively between the gear steps E2.1 and E2.2, and a gear change takes place while the other electric machine maintains the tractive force.

During a gear change, for example, from the forward gear step E1.1 into the forward gear step E1.2, the gearshift clutch B can be engaged in the second sub-transmission and, consequently, the second electric machine can maintain the tractive force during the gear change in the first sub-transmission 32.

In the purely internal combustion engine-driven operation or hybrid operation (i.e., for the case in which internal combustion engine-generated power and, optionally, electric motor-generated power are guided to the output shaft), it is advantageous that the third clutch K3 is utilized for connecting the second input shaft 26 to the first input shaft 24 and, consequently, always supplying internal combustion engine-generated power into the transmission arrangement 16 via the first input shaft 24. Consequently, the first electric machine 56 associated with the first sub-transmission 32 is always rotationally fixed to the internal combustion engine during this operation. As a result, it is possible to establish load-point displacements at the internal combustion engine 12 and the first electric machine 56 can provide assistance during the closed-loop control of the rotational speed when a synchronization process is to take place. In other words, since the first clutch K1 and the second clutch K2 always remain engaged, the first electric machine 56 can assist the internal combustion engine 12 during synchronization.

In order to integrate the third clutch K3, which is necessary therefor, into the transmission arrangement as efficiently as possible, the third clutch K3 is accommodated in the third gearshift clutch assembly 66. Since the third clutch K3 is therefore integrated with a gearshift clutch into a gearshift clutch assembly that is associated with that sub-transmission, the associated clutch K2 of which is always engaged in the internal combustion engine-driven or hybrid operation, the internal combustion engine 12 can utilize all gear steps of the transmission.

The second clutch K2 is disengaged, however, when a serial operation is established. Here, the first clutch K1 is engaged. Via the first sub-transmission 34 and the second electric machine 60, a purely electric motor-driven operation is established in a gear step, for example, in the forward gear step 2. The internal combustion engine 12 drives the first electric machine 56 via the engaged first clutch K1 and operates the first electric machine 56 as a generator, and so the power withdrawn from a vehicle battery by the second electric machine 60 in this purely electric operation can be simultaneously resupplied, at least partially, via the first electric machine 56.

The serial operation is utilized, in particular, in a crawling mode, in which the vehicle speed is lower than a minimum speed that is establishable by the internal combustion engine 12.

The sub-transmission 32 that is associated with the clutch K2, which is always engaged in the internal combustion engine-driven mode, preferably also includes the highest forward gear step of the transmission arrangement 16. As a result, when the third clutch is disengaged, the second electric machine 60 can be practically decoupled, in order to avoid drag losses. In addition, the first electric machine 56 can remain coupled, in order to supply the main power circuit with electrical energy (operation as a generator), or in order to establish a boost operation (operation as a motor).

During a gear shift from a forward gear step of the first sub-transmission 32 into a forward gear step of the second sub-transmission 34, the desired gear step is initially engaged in the second sub-transmission 34 by engaging the associated gearshift clutch (D or B). This takes place with the aid of a synchronization by the second electric machine 60, wherein the second electric machine 60 switches over, in a load-free manner, into the target gear step in the second sub-transmission 34. Thereafter, the second electric machine 60 supports the tractive force during the gear shift via the already engaged target gear step. During the gear shift, initially the gearshift clutch of the first sub-transmission 32, which is associated with the starting or source gear step, disengages and, thereafter, the third clutch K3 is engaged, wherein the internal combustion engine 12 and the first electric machine 56 interact during the synchronization.

During a gear shift from the second sub-transmission 34 into a gear step of the first sub-transmission 32, the second electric machine 60 initially supports the tractive force in the source gear step or the actual gear during the gear shift. During the gear shift, the third clutch K3 is initially disengaged and one of the shift elements A, C, E engages, wherein the internal combustion engine 12 and the first electric machine 56 interact during the necessary synchronization. After the disengagement of the third clutch K3 and the load transfer on the first sub-transmission 32, the output gear step (actual gear step) in the second sub-transmission 34 is disengaged.

It is understood that a stationary charging can also take place with the hybrid drive train when the vehicle is at a standstill. For example, the first clutch K1 can be engaged and input power of the internal combustion engine 12 is supplied via the intermediate shaft 74 into the first electric machine 56. The second clutch K2 remains disengaged. In this condition, a start of the internal combustion engine 12 can also take place by the first electric machine 56.

In general, it is also conceivable to engage both clutches K1 and K2, in order to allow a charging process to take place by the first electric machine 56 and also by the second electric machine 60. In this case, the internal combustion engine 12 drives both electric machines 56, 60, and both electric machines 56, 60 operate as generators, in order to charge a vehicle battery. All gearshift clutches A through E are disengaged in this case.

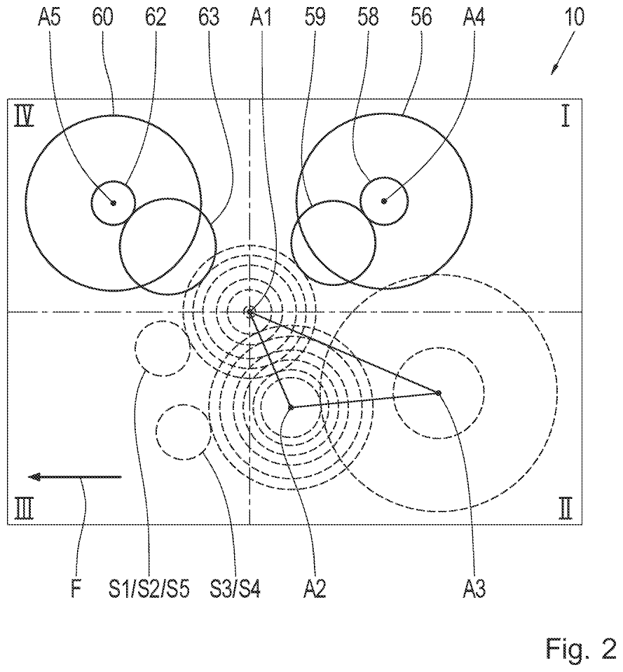

In FIG. 2, an axial view of a drive train 10 is represented, which can generally correspond to the drive train 10 from FIG. 1 with respect to configuration and mode of operation.

It is apparent that the axis A1 of the input shafts 24, 26 is situated in the center of a coordinate system having four quadrants I, II, III, and IV.

Since the drive train 10 is generally installed transversely in the direction of travel of a motor vehicle, a preferred forward direction of travel F is also represented in FIG. 2.

Of the four quadrants I-IV, a first quadrant I is situated above the input shaft arrangement 24, 26 and on a first longitudinal side (at the rear) of the input shaft arrangement 24, 26. A second quadrant II is situated underneath the input shaft arrangement and on the first longitudinal side. A third quadrant III is situated underneath the input shaft arrangement 24, 26 and is situated on a second longitudinal side (at the front) of the input shaft arrangement 24, 26. A fourth quadrant IV is situated above the input shaft arrangement and on the second longitudinal side of the input shaft arrangement.

The axis A2 of the countershaft 28 is situated in the second quadrant II. The axis A3 of the power distribution unit 18 is also situated in the second quadrant II. The axis A2 is arranged closer to the third quadrant III than the axis A3.

Actuating units S1-S5 are arranged in the third quadrant III.

The first electric machine 56 is completely arranged, with the axis A4, in the first quadrant I. The second electric machine 60 is completely arranged, with the axis A5, in the fourth quadrant IV.

The intermediate gear 59 is arranged completely in the first quadrant I. The intermediate gear 63 is arranged completely in the fourth quadrant IV.

The power distribution unit 18 is arranged predominantly in the second quadrant II, although the power distribution unit 18 can also extend into the first quadrant I.

The countershaft 28 with the gearwheels arranged thereon is arranged predominantly in the second quadrant II, although the countershaft 28 can also extend, with a few gearwheels, into the third quadrant III.

The longitudinal axis of the motor vehicle is then preferably aligned in parallel to the axis of the above-described coordinate system that separates the quadrants I, IV situated at the top from the quadrants II, III situated at the bottom.

The axis A3 is preferably situated coaxially to the driven wheels.

The drive train 10 can be arranged in the area of the front of the motor vehicle. Alternatively, however, the drive train 10 can also be arranged in the area of a rear of the motor vehicle. The longitudinal axis of the drive train 10 is aligned with the preferred forward direction of travel F. In any case, the drive train is installed in the transverse direction in the motor vehicle.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

10 motor vehicle drive train
12 internal combustion engine
14 clutch assembly (K1/K2)
16 hybrid transmission arrangement
18 power distribution unit
20 driven wheels
22 control device
24 first input shaft
26 second input shaft
27 input shaft arrangement
28 output shaft
30 output gear set
32 first sub-transmission
34 second sub-transmission
36 gear set (1)
38 gear set (3)
40 first gearshift clutch assembly (NE)
42 gear set (5)
48 gear set (2)
50 gear set (4)
52 second gearshift clutch assembly (D/B)
56 first electric machine (EM1)
58 first pinion (first machine pinion)
59 first intermediate gear
60 second electric machine (EM2)
62 second pinion (second machine pinion)
63 second intermediate gear
66 third gearshift clutch assembly (K3/C)
70 first gearwheel (first machine gearwheel)
72 second gearwheel (second machine gearwheel)
74 intermediate shaft
76 transmission arrangement input shaft
A1-A5 axes
A-E gearshift clutches for gear steps
K1 first clutch (separating clutch)
K2 second clutch
K3 third clutch (bridge clutch)
S1-S5 actuating units
P parking interlock gear

1-14: (canceled)

15. A hybrid transmission arrangement (16) for a motor vehicle drive train (10), comprising:
a first sub-transmission (32) with a first input shaft (24);
a second sub-transmission (34) with a second input shaft (26);
a first electric machine (56) connectable to the first input shaft (24) via a second clutch (K2); and
a second electric machine (60) connected to the second input shaft (26),
wherein the first electric machine (56) is connected via a first gearwheel (70) to an intermediate element (74), and the intermediate element (74) forms an input element of the second clutch (K2),
wherein the second electric machine (60) is connected to the second input shaft (26) via a second gearwheel (72), and
wherein the first gearwheel (70) is arranged coaxially and adjacent to the second gearwheel (72).

16. The hybrid transmission arrangement of claim 15, wherein the intermediate element (74) is connectable or connected via a first clutch (K1) to a transmission arrangement input shaft (76).

17. The hybrid transmission arrangement of claim 16, wherein one or both of the first gearwheel (70) and the intermediate element (74) is arranged axially between the second clutch (K2) and the first clutch (K1).

18. The hybrid transmission arrangement of claim 15, wherein the first input shaft (24) and the second input shaft (26) are connectable via a third clutch (K3).

19. The hybrid transmission arrangement of claim 18, wherein the third clutch (K3) and a gearshift clutch (C) for engaging a gear set (38) of a sub-transmission (32) form a gearshift clutch assembly (66).

20. The hybrid transmission arrangement of claim 15, wherein:
the first electric machine (56) is connected to the first gearwheel (70) via at least one first intermediate gearwheel (59); or
the second electric machine (60) is connected to the second gearwheel (72) via at least one second intermediate gearwheel (63); or
both the first electric machine (56) is connected to the first gearwheel (70) via the at least one first intermediate gearwheel (59) and the second electric machine (60) is connected to the second gearwheel (72) via the at least one second intermediate gearwheel (63).

21. The hybrid transmission arrangement of claim 15, wherein one or more of the first clutch (K1), the second clutch (K2), a third clutch (K3), and at least one gearshift clutch (A, B, C, D, E) of the transmission arrangement (16) is a dog clutch.

22. The hybrid transmission arrangement of claim 15, wherein the second gearwheel (72) is part of a gear-step gear set (50) of the second sub-transmission (34).

23. The hybrid transmission arrangement of claim 22, wherein the gear-step gear set (50) of the second sub-transmission (34) is associated with a highest gear step (4) of the second sub-transmission (34).

24. The hybrid transmission arrangement of claim 15, wherein the second electric machine (60) has a higher power than the first electric machine (56).

25. The hybrid transmission arrangement of claim 15, wherein an input shaft arrangement (27) formed by the first input shaft (24) and the second input shaft (26) is arranged at a center of four quadrants (I-IV) in an axial plane, a first quadrant (I) of the four quadrants (I-IV) is situated above the input shaft arrangement (27) and on a first longitudinal side of the input shaft arrangement (27), a second quadrant (II) of the four quadrants (I-IV) is situated below the input shaft arrangement (27) and on the first longitudinal side of the input shaft arrangement (27), a third quadrant (III) of the four quadrants (I-IV) is situated below the input shaft arrangement (27) and on a second longitudinal side of the input shaft arrangement (27), and a fourth quadrant (IV) of the four quadrants (I-IV) is situated above the input shaft arrangement (27) and on the second longitudinal side of the input shaft arrangement (27), and
wherein, one or more of:
an axis (A4) of one of the first and second electric machines (56, 60) is situated in the first quadrant (I), and an axis (A5) of the of the first and second electric machines (56, 60) is situated in the fourth quadrant (IV);
an axis (A2) of a countershaft (28) is situated in the second quadrant (II);
an axis (A3) of a power distribution unit is situated in the second quadrant (II); and
a plurality of actuating units (S1-S5) for actuating one or more of the first clutch, the second clutch, a third clutch, a gearshift clutch (A, C, E) for engaging a gear-step gear set (36, 38, 42) of the first sub-transmission (32), and a gearshift clutch (D, B) for engaging a gear-step gear set (50, 52) of the second sub-transmission (34) is situated in the third quadrant (III).

26. A method for operating the hybrid transmission arrangement of one of claim 15, comprising, in an internal combustion engine-driven operation or a hybrid operation:
utilizing gear steps (1, 3, 5) of the first sub-transmission (32) by engaging the first clutch (K1) and the second clutch (K2); and
utilizing gear steps (2, 4) of the second sub-transmission (34) by engaging the first clutch (K1), the second clutch (K2), and the third clutch (K3).

27. A method for operating the hybrid transmission arrangement of claim 15, comprising, in an internal combustion engine-driven operation:
disengaging the third clutch (K3) in a gear step of the first sub-transmission (32) in order to decouple the second sub-transmission (34) and the second electric machine (60) associated with the second sub-transmission (34).

28. A method for operating the hybrid transmission arrangement of claim 15, comprising, in a purely electric motor-driven operation:
one or both of providing input power of the first electric machine (56) via the first sub-transmission (32) and providing input power of the second electric machine (60) via the second sub-transmission (34); and
wherein, while a gear change is carried out in the second sub-transmission, the first clutch (K1) is disengaged, a powershift is implemented, or both the first clutch (K1) is disengaged and the powershift is implemented, and
wherein one or both of the first electric machine (56) maintains tractive force via the first sub-transmission (32) and the second electric machine (60) maintains tractive force via the second sub-transmission (34) when the powershift is implemented.
